(19) United States
(12) Patent Application Publication
(10) Pub. No.: US 2026/0067778 A1
(43) Pub. Date: Mar. 5, 2026

(54) REPORTING FOR USER EQUIPMENT ADJUSTED MOBILITY PARAMETERS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/298,846

(22) Filed: Aug. 13, 2025

Related U.S. Application Data
(60) Provisional application No. 63/687,556, filed on Aug. 27, 2024.

(51) Int. Cl. H04W 36/30; H04W 36/08; H04W 36/24

(52) U.S. Cl. CPC H04W 36/30; H04W 36/08; H04W 36/249

(57) ABSTRACT

Various aspects of the present disclosure generally relate to wireless communication. In some aspects, a user equipment (UE) may receive, from a network node, a configuration allowing an adjustment within a range to a configured value associated with a mobility parameter and indicating one or more conditions associated with the adjustment to the configured value. The UE may adjust the configured value associated with the mobility parameter in accordance with the one or more conditions being satisfied. The UE may transmit, to the network node, information related to adjusting the configured value associated with the mobility parameter. In some aspects, the transmitted information indicates one or more of an adjusted value associated with the mobility parameter or a reason for adjusting the configured value associated with the mobility parameter. Numerous other aspects are described.

### CROSS-REFFERENCE TO RELATED APPLICATION

This Patent Application claims priority to U.S. Provisional Patent Application No. 63/687,556, filed on August 27, 2024, entitled “REPORTING FOR USER EQUIPMENT ADJUSTED MOBILITY PARAMETERS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with reporting for user equipment (UE) adjusted mobility parameters.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a make-before-break handover procedure, in accordance with the present disclosure.

FIG. 5 is a diagram illustrating an example of a conditional handover procedure, in accordance with the present disclosure.

FIG. 6 is a diagram illustrating an example of a Layer 1 or Layer 2 triggered mobility procedure, in accordance with the present disclosure.

FIG. 7 is a diagram illustrating examples of handover failures, in accordance with the present disclosure.

FIGS. 8A-8B are diagrams illustrating examples associated with reporting for UE-adjusted mobility parameters, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIGS. 11-12 are diagrams of example apparatuses for wireless communication, in accordance with the present disclosure.

### SUMMARY

Some aspects described herein relate to a method of wireless communication performed by a user equipment (UE). The method may include receiving, from a network node, a configuration allowing an adjustment within a range to a configured value associated with a mobility parameter and indicating one or more conditions associated with the adjustment to the configured value. The method may include adjusting, within the range, the configured value associated with the mobility parameter in accordance with the one or more conditions being satisfied. The method may include transmitting, to the network node, information related to adjusting the configured value associated with the mobility parameter. In some aspects, the transmitted information indicates one or more of an adjusted value associated with the mobility parameter or a reason for adjusting the configured value associated with the mobility parameter.

Some aspects described herein relate to a method of wireless communication performed by a network node. The method may include transmitting, to a UE, a configuration allowing an adjustment within a range to a configured value associated with a mobility parameter and indicating one or more conditions associated with the adjustment to the configured value. The method may include receiving, from the UE, information related to the UE adjusting, within the range, the configured value associated with the mobility parameter. In some aspects, the received information indicates one or more of an adjusted value associated with the mobility parameter or a reason for adjusting the configured value associated with the mobility parameter.

Some aspects described herein relate to a UE for wireless communication. The UE may include one or more memories and one or more processors coupled to the one or more memories. The one or more processors may be configured to receive, from a network node, a configuration allowing an adjustment within a range to a configured value associated with a mobility parameter and indicating one or more conditions associated with the adjustment to the configured value. The one or more processors may be configured to adjust, within the range, the configured value associated with the mobility parameter in accordance with the one or more conditions being satisfied. The one or more processors may be configured to transmit, to the network node, information related to adjusting the configured value associated with the mobility parameter. In some aspects, the transmitted information indicates one or more of an adjusted value associated with the mobility parameter or a reason for adjusting the configured value associated with the mobility parameter.

Some aspects described herein relate to a network node for wireless communication. The network node may include one or more memories and one or more processors coupled to the one or more memories. The one or more processors may be configured to transmit, to a UE, a configuration allowing an adjustment within a range to a configured value associated with a mobility parameter and indicating one or more conditions associated with the adjustment to the configured value. The one or more processors may be configured to receive, from the UE, information related to the UE adjusting, within the range, the configured value associated with the mobility parameter. In some aspects, the received information indicates one or more of an adjusted value associated with the mobility parameter or a reason for adjusting the configured value associated with the mobility parameter.

Some aspects described herein relate to a non-transitory computer-readable medium that stores a set of instructions for wireless communication by a UE. The set of instructions, when executed by one or more processors of the UE, may cause the UE to receive, from a network node, a configuration allowing an adjustment within a range to a configured value associated with a mobility parameter and indicating one or more conditions associated with the adjustment to the configured value. The set of instructions, when executed by one or more processors of the UE, may cause the UE to adjust, within the range, the configured value associated with the mobility parameter in accordance with the one or more conditions being satisfied. The set of instructions, when executed by one or more processors of the UE, may cause the UE to transmit, to the network node, information related to adjusting the configured value associated with the mobility parameter. In some aspects, the transmitted information indicates one or more of an adjusted value associated with the mobility parameter or a reason for adjusting the configured value associated with the mobility parameter.

Some aspects described herein relate to a non-transitory computer-readable medium that stores a set of instructions for wireless communication by a network node. The set of instructions, when executed by one or more processors of the network node, may cause the network node to transmit, to a UE, a configuration allowing an adjustment within a range to a configured value associated with a mobility parameter and indicating one or more conditions associated with the adjustment to the configured value. The set of instructions, when executed by one or more processors of the network node, may cause the network node to receive, from the UE, information related to the UE adjusting, within the range, the configured value associated with the mobility parameter. In some aspects, the received information indicates one or more of an adjusted value associated with the mobility parameter or a reason for adjusting the configured value associated with the mobility parameter.

Some aspects described herein relate to an apparatus for wireless communication. The apparatus may include means for receiving, from a network node, a configuration allowing an adjustment within a range to a configured value associated with a mobility parameter and indicating one or more conditions associated with the adjustment to the configured value. The apparatus may include means for adjusting, within the range, the configured value associated with the mobility parameter in accordance with the one or more conditions being satisfied. The apparatus may include means for transmitting, to the network node, information related to adjusting the configured value associated with the mobility parameter. In some aspects, the transmitted information indicates one or more of an adjusted value associated with the mobility parameter or a reason for adjusting the configured value associated with the mobility parameter.

Some aspects described herein relate to an apparatus for wireless communication. The apparatus may include means for transmitting, to a UE, a configuration allowing an adjustment within a range to a configured value associated with a mobility parameter and indicating one or more conditions associated with the adjustment to the configured value. The apparatus may include means for receiving, from the UE, information related to the UE adjusting, within the range, the configured value associated with the mobility parameter. In some aspects, the received information indicates one or more of an adjusted value associated with the mobility parameter or a reason for adjusting the configured value associated with the mobility parameter.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Handover procedures are generally used in wireless networks to maintain seamless connectivity when a wireless link between a user equipment (UE) and a serving cell becomes degraded and/or a wireless link to a neighbor cell improves or becomes better than the serving cell. For example, a UE may be configured to obtain measurements for one or more parameters that relate to channel quality associated with the serving cell and one or more neighbor cells and to provide the measurements to the serving cell. The serving cell then determines whether a handover to a target (neighbor) cell may be needed based on the measurements provided by the UE. In cases where the serving cell determines that a handover to a target cell is needed, the serving cell communicates with the target cell to prepare for the handover, sends a handover command to the UE to instruct the UE to disconnect from the serving cell and connect to the target cell, and releases network resources allocated to the UE when the handover is successful and the connection to the target cell is confirmed.

In general, handover techniques are managed in accordance with various mobility parameters. For example, a network node may provide a UE with a radio resource control (RRC) configuration that indicates configured values for various mobility parameters, such as values for one or more thresholds that are used to evaluate serving cell measurements and/or neighbor cell measurements, one or more hysteresis parameters that define margins to stabilize handover decisions and avoid frequent and/or unnecessary handovers that result from short-term fluctuations in signal strengths, and/or one or more time-to-trigger (TTT) parameters that define a delay between a time when a handover condition is satisfied and a time when the handover is triggered or initiated to further ensure that handovers are triggered only when necessary (e.g., a handover may be initiated when the handover condition is still satisfied after the TTT period expires, or aborted when signal qualities change such that the handover condition ceases to be satisfied before the TTT period expires). For example, a measurement report may be triggered, or a handover condition may be satisfied, when a serving cell measurement fails to satisfy a threshold, when a difference between a neighbor cell measurement and a serving cell measurement satisfies a threshold, when a neighbor cell measurement satisfies a threshold, and/or when a serving cell measurement fails to satisfy a first threshold and a neighbor cell measurement satisfies a second threshold, among other examples. In some cases, each event that triggers a measurement report or satisfies a handover condition may be associated with one or more mobility parameters, such as values for the relevant threshold(s), hysteresis parameter(s), offset(s), and/or TTT parameter(s).

Although handover procedures and the configured values for mobility parameters are generally defined to ensure seamless mobility, there are various circumstances where a handover failure or mobility failure may occur. For example, in some cases, a mobility failure may occur when a UE experiences radio link failure (RLF) in a source cell and recovers from the RLF in a target cell, when a UE experiences RLF in a target cell following a handover and recovers from the RLF in a source cell or a different neighbor cell, when a first handover is triggered from a source cell to a target cell and a second handover is triggered from the target cell back to the original source cell, and/or when a handover is triggered to a target cell even though coverage provided by the source cell was adequate for a service used by the UE. Accordingly, in some cases, a wireless network may support mobility robustness optimization (MRO) techniques to detect and correct mobility failures. For example, network nodes associated with different serving cells may be configured to provide handover reports, failure indications, RLF reports, and/or other information that indicates whether a handover succeeded or failed, such that one or more mobility parameters may be tuned or optimized to reduce mobility failures (e.g., changing values for one or more thresholds, hysteresis parameters, TTT parameters, and/or other suitable mobility parameters). Furthermore, in some cases, a UE may be configured to adjust the values for one or more mobility parameters prior to and/or during a handover procedure. For example, a UE may increase or decrease a configured value for one or more thresholds, hysteresis parameters, TTT parameters, or the like, to prevent a handover to a potentially unsuitable target cell and/or to accelerate a handover from an unsuitable serving cell and/or to a suitable target cell. However, when a UE adjusts the values for one or more mobility parameters, the UE does not provide information related to the adjustment to the mobility parameters to a network node. Accordingly, mobility parameters are tuned or optimized only according to the MRO signaling between network nodes, which may result in suboptimal parameter tuning and additional mobility failures that consume resources and interrupt communications.

Various aspects relate generally to a reporting configuration for UE-adjusted mobility parameters. Some aspects more specifically relate to using a minimization of drive test (MDT) configuration or another suitable configuration to obtain, from a UE, information related to the UE adjusting one or more mobility parameters such that the information can be used to tune values for one or more thresholds, hysteresis parameters, TTT parameters, or the like (e.g., in combination with MRO statistics that are collected from handover reports, failure reports, or other information communicated between and among network nodes when a handover succeeds or fails). For example, when a UE indicates a capability to support UE-adjusted mobility, a network node may provide the UE with a configuration that allows the UE to adjust configured values for one or more mobility parameters. In some aspects, when the configuration indicates that the UE is allowed to adjust configured values for one or more mobility parameters, the configuration may further indicate constraints for the adjustment to the configured values for the one or more mobility parameters (e.g., one or more conditions under which the UE is allowed to adjust configured values for one or more mobility parameters and/or a range within which the configured values can be adjusted). Accordingly, when the UE adjusts the configured values for one or more mobility parameters, the UE may be configured to transmit, to the network node, information related to the adjustment to the mobility parameters. For example, in some aspects, the information related to the adjustment to the mobility parameters may indicate the configured values for the adjusted mobility parameters, the adjusted values for the mobility parameters, and/or a reason or cause for the adjustment to the configured values for the mobility parameters, among other examples.

Particular aspects of the subject matter described in this disclosure can be implemented to realize one or more of the following potential advantages. In some examples, by configuring a UE to report information related to an adjustment to configured values for one or more mobility parameters, the described techniques can be used to obtain information from UEs that may be used, alone or in combination with MRO statistics, to tune or otherwise optimize values for one or more mobility parameters. In this way, the values for one or more mobility parameters may be tuned or optimized to reduce mobility failures or handover failures, which conserves UE resources and network resources that would otherwise be consumed and prevents service interruptions that would otherwise occur when a UE experiences RLF before a handover is triggered, when a UE experiences RLF occurs after a handover is triggered, when ping-pong handovers occur, and/or when a handover is unnecessarily triggered from a serving cell that provides acceptable performance for a UE service.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

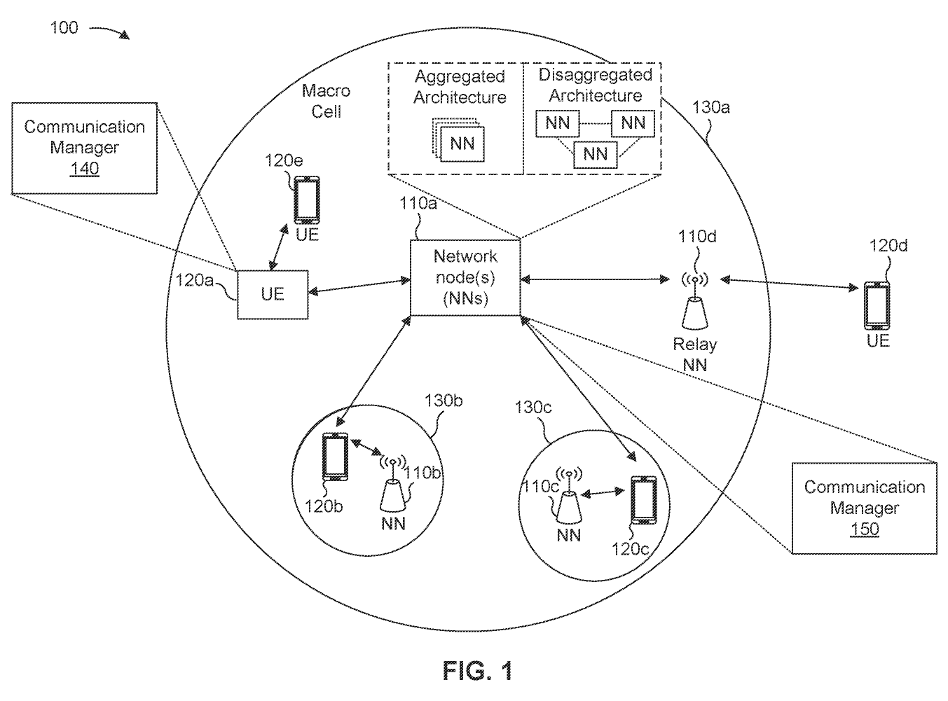

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c.Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a network node 110, a configuration allowing an adjustment within a range to a configured value associated with a mobility parameter and indicating one or more conditions associated with the adjustment to the configured value; adjust, within the range, the configured value associated with the mobility parameter in accordance with the one or more conditions being satisfied; and transmit, to the network node 110, information related to adjusting the configured value associated with the mobility parameter. In some aspects, the transmitted information indicates one or more of an adjusted value associated with the mobility parameter or a reason for adjusting the configured value associated with the mobility parameter. Additionally, or alternatively, the communication manager 140 may perform one or more other operations described herein.

In some aspects, the network node 110 may include a communication manager 150. As described in more detail elsewhere herein, the communication manager 150 may transmit, to a UE 120, a configuration allowing an adjustment within a range to a configured value associated with a mobility parameter and indicating one or more conditions associated with the adjustment to the configured value; and receive, from the UE 120, information related to the UE adjusting, within the range, the configured value associated with the mobility parameter. In some aspects, the received information indicates one or more of an adjusted value associated with the mobility parameter or a reason for adjusting the configured value associated with the mobility parameter. Additionally, or alternatively, the communication manager 150 may perform one or more other operations described herein.

As indicated above, FIG. 1 is provided as an example. Other examples may differ from what is described with regard to FIG. 1.

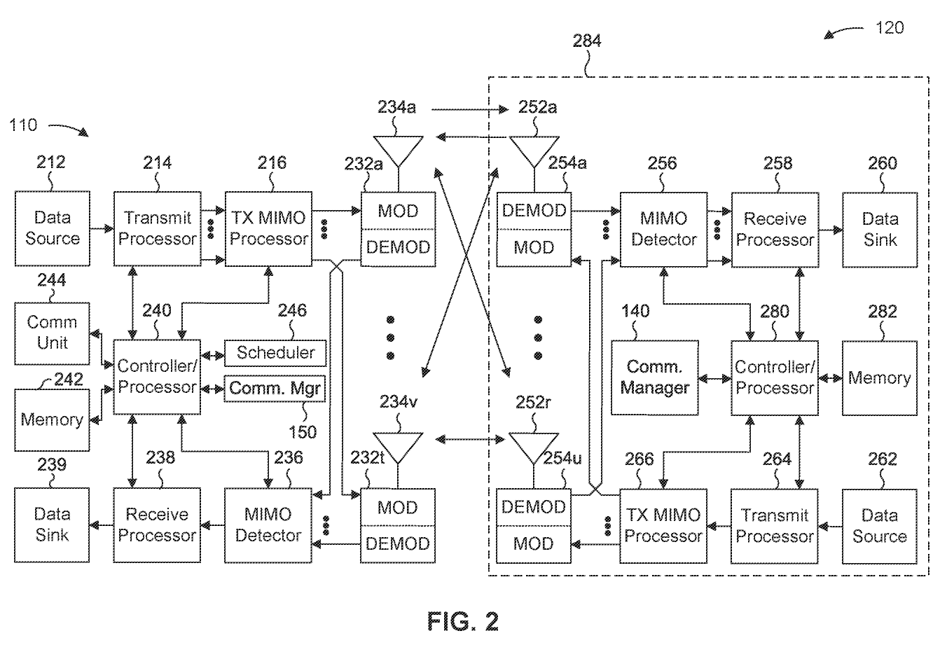

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t ≥ 1), a set of antennas 234 (shown as 234a through 234v, where v ≥ 1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r ≥ 1), a set of modems 254 (shown as modems 254a through 254u, where u ≥ 1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

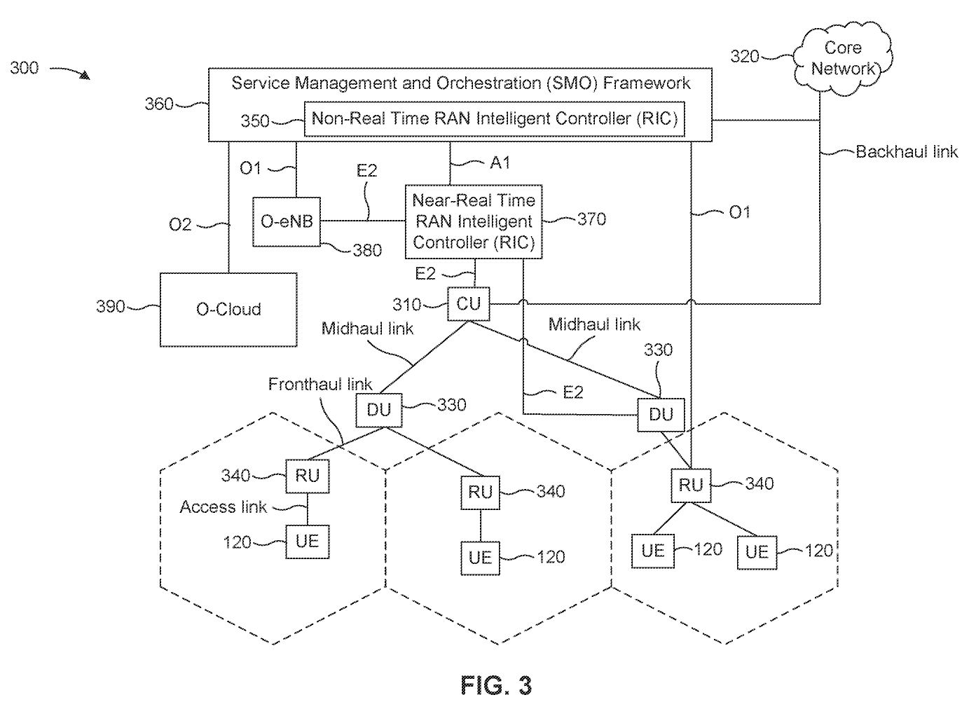

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

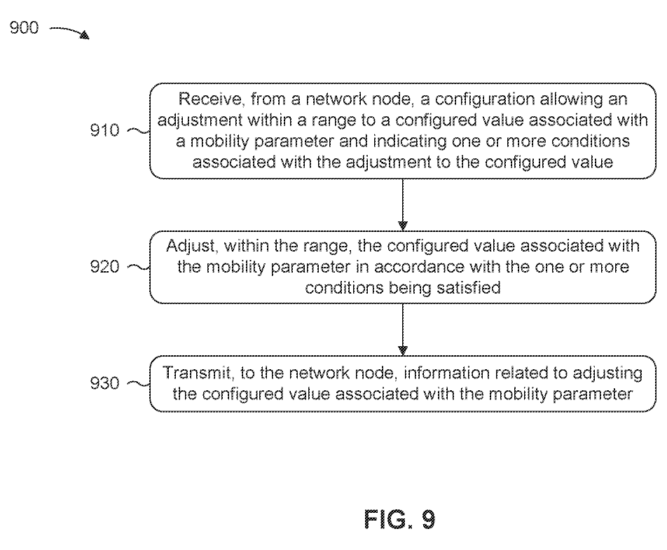

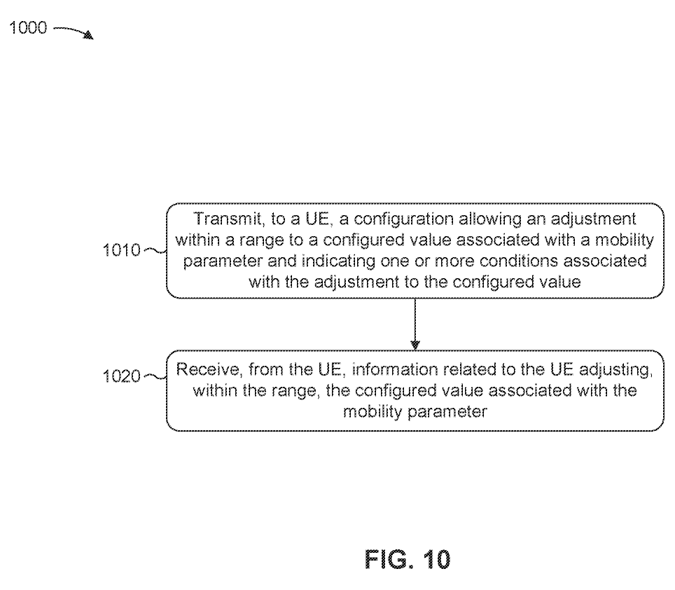

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with reporting for UE-adjusted mobility parameters, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving, from a network node 110, a configuration allowing an adjustment within a range to a configured value associated with a mobility parameter and indicating one or more conditions associated with the adjustment to the configured value; means for adjusting, within the range, the configured value associated with the mobility parameter in accordance with the one or more conditions being satisfied; and/or means for transmitting, to the network node 110, information related to adjusting the configured value associated with the mobility parameter. In some aspects, the transmitted information indicates one or more of an adjusted value associated with the mobility parameter or a reason for adjusting the configured value associated with the mobility parameter. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, a configuration allowing an adjustment within a range to a configured value associated with a mobility parameter and indicating one or more conditions associated with the adjustment to the configured value; and/or means for receiving, from the UE 120, information related to the UE adjusting, within the range, the configured value associated with the mobility parameter. In some aspects, the received information indicates one or more of an adjusted value associated with the mobility parameter or a reason for adjusting the configured value associated with the mobility parameter. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

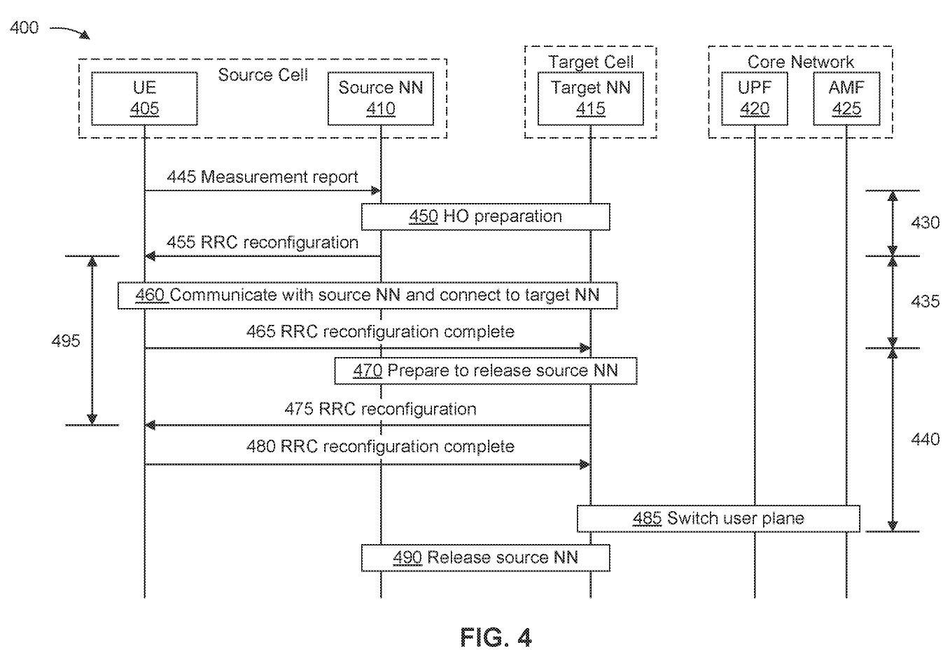

FIG. 4 is a diagram illustrating an example 400 of a make-before-break (MBB) handover procedure, in accordance with the present disclosure.

As shown in FIG. 4, the MBB handover procedure may involve a UE 405, a source network node 410, a target network node 415, a user plane function (UPF) device 420, and an AMF device 425. In some examples, actions described as being performed by a network node may be performed by multiple network nodes. For example, configuration actions and/or core network communication actions may be performed by a first network node (e.g., a CU or a DU), and radio communication actions may be performed by a second network node (e.g., a DU or an RU). The UE 405 may correspond to the UE 120 described elsewhere herein. The source network node 410 and/or the target network node 415 may correspond to the network node 110 described elsewhere herein. The UE 405 and the source network node 410 may be connected (e.g., may have an RRC connection) via a serving cell or a source cell, and the UE 405 may undergo a handover to the target network node 415 via a target cell. The UPF device 420 and/or the AMF device 425 may be located within a core network. The source network node 410 and the target network node 415 may be in communication with the core network for mobility support and user plane functions.

As shown in FIG. 4, the MBB handover procedure may include a handover preparation phase 430, a handover execution phase 435, and a handover completion phase 440. During the handover preparation phase 430, the UE 405 may report measurements that cause the source network node 410 and/or the target network node 415 to prepare for handover and trigger execution of the handover. During the handover execution phase 435, the UE 405 may execute the handover by performing a random access procedure with the target network node 415 and establishing an RRC connection with the target network node 415. During the handover completion phase 440, the source network node 410 may forward one or more stored communications associated with the UE 405 to the target network node 415, and the UE 405 may be released from a connection with the source network node 410.

As shown by reference number 445, during the handover preparation phase 430, the UE 405 may perform one or more measurements, and may transmit a measurement report to the source network node 410 based at least in part on the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 410 may use the measurement report to determine whether to trigger a handover to the target network node 415. For example, if one or more measurements satisfy a condition, the source network node 410 may trigger a handover of the UE 405 to the target network node 415.

As shown by reference number 450, during the handover preparation phase 430, the source network node 410 and the target network node 415 may communicate with one another to prepare for a handover of the UE 405. As part of the handover preparation, the source network node 410 may transmit a handover request to the target network node 415 to instruct the target network node 415 to prepare for the handover. The source network node 410 may communicate RRC context information associated with the UE 405 and/or configuration information associated with the UE 405 to the target network node 415. The target network node 415 may prepare for the handover by reserving resources for the UE 405. After reserving the resources, the target network node 415 may transmit an acknowledgement (ACK) to the source network node 410 in response to the handover request.

As shown by reference number 455, during the handover preparation phase 430, the source network node 410 may transmit an RRC reconfiguration message to the UE 405. The RRC reconfiguration message may include a handover command instructing the UE 405 to execute a handover procedure from the source network node 410 to the target network node 415. The handover command may include information associated with the target network node 415, such as a random access channel (RACH) preamble assignment for accessing the target network node 415. Reception of the RRC reconfiguration message, including the handover command, by the UE 405 may trigger the start of the handover execution phase 435.

As shown by reference number 460, during the handover execution phase 435, the UE 405 may execute the handover by performing a random access procedure with the target network node 415 (e.g., including synchronization with the target network node 415) while continuing to communicate with the source network node 410. For example, while the UE 405 is performing the random access procedure with the target network node 415, the UE 405 may transmit uplink data, uplink control information, and/or an uplink reference signal (e.g., an SRS) to the source network node 410, and/or may receive downlink data, DCI, and/or a downlink reference signal from the source network node 410.

As shown by reference number 465, upon successfully establishing a connection with the target network node 415 (e.g., via a random access procedure) during the handover execution phase 435, the UE 405 may transmit an RRC reconfiguration completion message to the target network node 415. Reception of the RRC reconfiguration message by the target network node 415 may trigger the start of the handover completion phase 440.

As shown by reference number 470, during the handover completion phase 440, the source network node 410 and the target network node 415 may communicate with one another to prepare for release of the connection between the source network node 410 and the UE 405. In some aspects, the target network node 415 may determine that a connection between the source network node 410 and the UE 405 is to be released, such as after receiving the RRC reconfiguration message from the UE 405. In this case, the target network node 415 may transmit a handover connection setup completion message to the source network node 410. The handover connection setup completion message may cause the source network node 410 to stop transmitting data to the UE 405 and/or to stop receiving data from the UE 405. Additionally, or alternatively, the handover connection setup completion message may cause the source network node 410 to forward communications associated with the UE 405 to the target network node 415 and/or to notify the target network node 415 of a status of one or more communications with the UE 405. For example, the source network node 410 may forward, to the target network node 415, buffered downlink communications (e.g., downlink data) for the UE 405 and/or uplink communications (e.g., uplink data) received from the UE 405. Additionally, or alternatively, the source network node 410 may notify the target network node 415 regarding a PDCP status associated with the UE 405 and/or a sequence number to be used for a downlink communication with the UE 405.

As shown by reference number 475, during the handover completion phase 440, the target network node 415 may transmit an RRC reconfiguration message to the UE 405 to instruct the UE 405 to release the connection with the source network node 410. Upon receiving the instruction to release the connection with the source network node 410, the UE 405 may stop communicating with the source network node 410. For example, the UE 405 may refrain from transmitting uplink communications to the source network node 410 and/or may refrain from monitoring for downlink communications from the source network node 410.

As shown by reference number 480, during the handover completion phase 440, the UE may transmit an RRC reconfiguration completion message to the target network node 415 to indicate that the connection between the source network node 410 and the UE 405 is being released or has been released.

As shown by reference number 485, during the handover completion phase 440, the target network node 415, the UPF device 420, and/or the AMF device 425 may communicate to switch a user plane path of the UE 405 from the source network node 410 to the target network node 415. Prior to switching the user plane path, downlink communications for the UE 405 may be routed through the core network to the source network node 410. After the user plane path is switched, downlink communications for the UE 405 may be routed through the core network to the target network node 415. Upon completing the switch of the user plane path, the AMF device 425 may transmit an end marker message to the source network node 410 to signal completion of the user plane path switch. As shown by reference number 490, the target network node 415 and the source network node 410 may communicate to release the source network node 410.

As part of the MBB handover procedure, the UE 405 may maintain simultaneous connections with the source network node 410 and the target network node 415 during a time period 495. The time period 495 may start at the beginning of the handover execution phase 435 (e.g., upon reception by the UE 405 of a handover command from the source network node 410) when the UE 405 performs a random access procedure with the target network node 415. The time period 495 may end upon release of the connection between the UE 405 and the source network node 410 (e.g., upon reception by the UE 405 of an instruction, from the target network node 415, to release the source network node 410). By maintaining simultaneous connections with the source network node 410 and the target network node 415, the handover procedure can be performed with zero or a minimal interruption to communications, thereby reducing latency.

As indicated above, FIG. 4 is provided as an example. Other examples may differ from what is described with regard to FIG. 4.

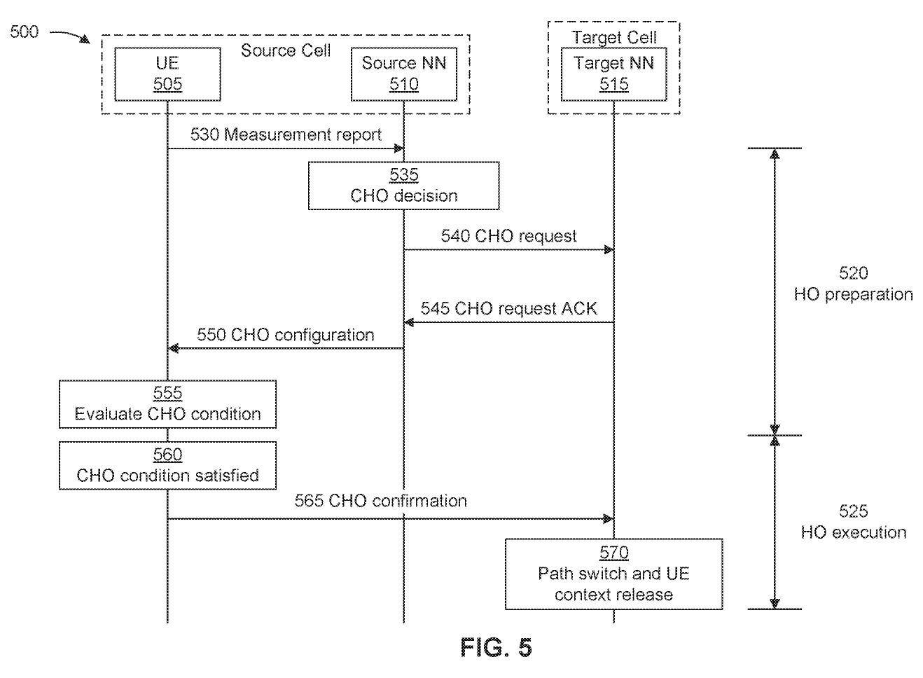

FIG. 5 is a diagram illustrating an example 500 of a conditional handover procedure in accordance with the present disclosure. As shown in FIG. 5, the conditional handover procedure may involve a UE 505, a source network node 510, and a target network node 515. In some examples, actions described as being performed by a network node may be performed by multiple network nodes. The UE 505 and the source network node 510 may be connected (e.g., may have an RRC connection) via a serving cell or a source cell, and the UE 505 may undergo a conditional handover to the target network node 515 via a target cell.

As shown in FIG. 5, the conditional handover procedure may include a handover preparation phase 520 and a handover execution phase 525. During the handover preparation phase 520, the source network node 510 may prepare one or more candidate target cells in advance, and may send a conditional handover configuration to the UE 505 when radio conditions between the UE 505 and the source network node 510 are not degraded. When the conditional handover configuration is received, the UE 505 stores a conditional handover message, and applies the stored conditional handover message only when a configured condition is satisfied for a configured candidate target cell. During the handover execution phase 525, the UE 505 may execute the handover by performing a random access procedure with the target network node 515 and establishing an RRC connection with the target network node 515 based on a configured condition being satisfied for the target network node 515. Accordingly, as described herein, the conditional handover procedure may reduce handover failure occurrences (e.g., where a handover is not triggered because a measurement report transmitted by the UE 505 does not reach the source network node 510 and/or because a handover command transmitted by the source network node 510 does not reach the UE 505 due to degraded signal conditions between the UE 505 and the source network node 510).

For example, as shown by reference number 530, during the handover preparation phase 520, the UE 505 may transmit, and the source network node 510 may receive, a measurement report that indicates measurements related to a signal strength (e.g., RSRP measurements, RSSI measurements, RSRQ measurements, and/or CQI values) or other suitable measurements associated with the source cell and/or one or more neighboring cells. In some examples, as shown by reference number 535, the source network node 510 may configure a conditional handover based on the measurement report provided by the UE 505 or other suitable information. For example, as shown by reference number 540, the source network node 510 may transmit a conditional handover request to the target network node 515 to instruct the target network node 515 to prepare for a potential handover. The source network node 510 may communicate RRC context information associated with the UE 505 and/or configuration information associated with the UE 505 to the target network node 515. The target network node 515 may prepare for the potential handover by reserving resources for the UE 505. After reserving the resources, as shown by reference number 545, the target network node 515 may transmit an ACK in response to the conditional handover request to the source network node 510.

As further shown by reference number 550, the source network node 510 may transmit, and the UE 505 may receive, a conditional handover configuration. For example, in some aspects, the conditional handover configuration may include a handover command to trigger a handover from the source network node 510 to the target network node 515, and the conditional handover configuration may further indicate one or more conditions associated with the conditional handover command. Accordingly, the UE 505 may generally store the conditional handover command, and may execute the conditional handover command only when an associated condition is satisfied. For example, in some aspects, the one or more conditions may instruct the UE 505 to execute the conditional handover command when a measurement associated with the source network node 510 fails to satisfy a threshold, when a difference between a measurement associated with the target network node 515 and a measurement associated with the source network node 510 satisfies a threshold, when a measurement associated with the target network node 515 satisfies a threshold, and/or when a measurement associated with the source network node 510 fails to satisfy a first threshold and a measurement associated with the target network node 515 satisfies a second threshold, among other examples.

Accordingly, as shown by reference number 555, the UE 505 may evaluate the conditional handover condition indicated by the source network node 510. For example, the UE 505 may obtain a measurement associated with the source network node 510 and/or a measurement associated with the target network node 515, and may determine whether the measurement associated with the source network node 510 and/or the measurement associated with the target network node 515 satisfy the condition associated with the conditional handover command. In cases where the condition associated with the conditional handover command is not satisfied, the UE 505 does not execute the conditional handover command, and may re-evaluate the condition associated with the conditional handover command at a later time. Alternatively, as shown by reference number 560, the UE 505 may determine that the condition associated with the conditional handover command is satisfied. In such cases, as shown by reference number 565, the UE 505 executes the conditional handover command, and communicates with the target network node 515 to confirm the conditional handover. As shown by reference number 570, the target network node 515 may perform a path switch to switch a user plane path of the UE 505 from the source network node 510 to the target network node 515. Prior to switching the user plane path, downlink communications for the UE 505 may be routed through the source network node 510. After the user plane path is switched, downlink communications for the UE 505 may be routed through the target network node 515. Upon completing the switch of the user plane path, a core network node may transmit an end marker message to the source network node 510 o signal completion of the user plane path switch, and the target network node 515 may communicate with the source network node 510 to release a context associated with the UE 505 at the source network node 510.

As indicated above, FIG. 5 is provided as an example. Other examples may differ from what is described with regard to FIG. 5.

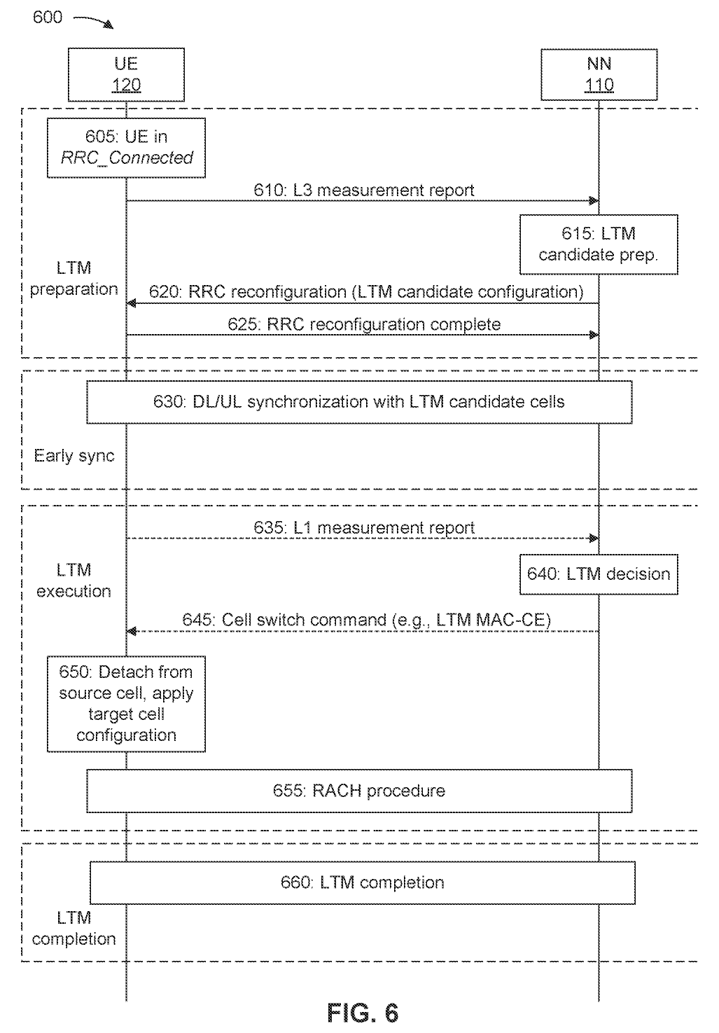

FIG. 6 is a diagram illustrating an example 600 of a Layer 1 (L1) or Layer 2 (L2) triggered mobility (LTM) procedure, in accordance with the present disclosure. As shown in FIG. 6, example 600 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink.

In some examples, the network node 110 may instruct the UE 120 to change or switch serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a Layer 3 (L3) handover procedure, such as the MBB handover procedure shown in FIG. 4, which may be referred to herein as a legacy handover procedure. In an L3 handover procedure, the network node 110 may transmit, to the UE 120, an RRC reconfiguration message indicating that the UE 120 is to perform a handover procedure to a target cell. For example, the network node 110 may transmit the reconfiguration message triggering the handover to the target cell in response to the UE 120 providing the network node 110 with an L3 measurement report indicating signal strength measurements associated with one or more cells (e.g., measurements associated with the source cell and/or one or more neighboring cells). In response to the RRC reconfiguration message, the UE 120 may communicate with the source cell and the target cell to detach from the source cell and connect to the target cell (e.g., the UE 120 may perform a contention-free RACH procedure in the target cell to establish an RRC connection with the target cell in accordance with a contention-free random access (CFRA) configuration indicated in the RRC reconfiguration message). Once handover is complete, the target cell may communicate with a UPF of a core network to instruct the UPF to switch a user plane path of the UE 120 from the source cell to the target cell. The target cell may also communicate with the source cell to indicate that handover is complete and that the source cell may be released.

As described herein, L3 handover procedures may be associated with high latency and high overhead due to the multiple RRC reconfiguration messages and/or other L3 signaling and operations used to perform the handover procedures. Accordingly, in some examples, a UE 120 may be configured to perform an LTM procedure, such as the LTM procedure shown in FIG. 6, which uses L1/L2 signaling to significantly reduce a handover latency relative to a legacy L3 handover procedure. For example, as shown in FIG. 6, the LTM procedure may include an LTM preparation phase, an early synchronization phase (shown as “early sync” in FIG. 6), an LTM execution phase, and an LTM completion phase.

As shown by reference number 605, during the LTM preparation phase, the UE 120 may be in an RRC connected state (sometimes referred to as RRC_Connected) with a source cell provided by the network node 110. As shown by reference number 610, the UE 120 may transmit, and the network node 110 may receive, an L3 measurement report (sometimes referred to as a MeasurementReport), which may indicate measurements related to a signal strength (e.g., RSRP measurements, RSSI measurements, RSRQ measurements, and/or CQI values) or other suitable measurements associated with the source cell and/or one or more neighboring cells. In some examples, based at least in part on the L3 measurement report or other information, the network node 110 may configure LTM for UE 120. Accordingly, as shown by reference number 615, the network node 110 may perform LTM candidate preparation. For example, during the LTM candidate preparation, the network node 110 may obtain configuration information for one or more LTM candidate cells (e.g., one or more parameters related to an identity for each LTM candidate cell, a synchronization and/or measurement configuration for each LTM candidate cell, and/or a full RRC configuration message associated with each LTM candidate cell, among other examples).

As shown by reference number 620, the network node 110 may transmit, and the UE 120 may receive, an RRC reconfiguration message (sometimes referred to as an RRCReconfiguration message), which may include an LTM configuration. More particularly, the LTM configuration included in the RRC reconfiguration message may indicate the configuration information for one or more LTM candidate cells (e.g., obtained during the LTM candidate preparation), which may be candidate cells to become a serving cell of the UE 120 and/or cells for which the UE 120 may later be triggered to perform an LTM procedure. As shown by reference number 625, the UE 120 may store the configuration information for the one or more LTM candidate cells and may transmit, in response to the RRC reconfiguration message, an RRC reconfiguration complete message (sometimes referred to as an RRCReconfigurationComplete message) to the network node 110.

As shown by reference number 630, during the early synchronization phase, the UE 120 may optionally perform downlink synchronization and/or uplink synchronization with the LTM candidate cells associated with the one or more LTM candidate cell configurations. For example, the UE 120 may perform downlink synchronization and timing advance acquisition with the one or more LTM candidate cells prior to receiving an LTM cell switch command. In some aspects, performing the early synchronization with the one or more candidate cells may reduce latency associated with performing a RACH procedure later in the LTM procedure, which is described in more detail below in connection with reference number 655. For example, the UE 120 may acquire the timing advance for an LTM candidate cell in accordance with a measured timing advance indicated in the configuration information for the LTM candidate cell and/or by using PRACH transmission parameters indicated in the configuration information (e.g., in an early synchronization configuration, which may be provided in an EarlyUL-SyncConfig parameter) to transmit a PRACH to the LTM candidate cell.

As shown by reference number 635, during the LTM execution phase, the UE 120 may obtain L1 measurements associated with the configured LTM candidate cells, and may transmit, to the network node 110, one or more L1 measurement reports associated with the configured LTM candidate cells. As shown by reference number 640, based at least in part on the L1 measurement report(s), the network node 110 may decide to execute an LTM cell switch to an LTM target cell (e.g., included among the configured LTM candidate cells). Accordingly, as shown by reference number 645, the network node 110 may transmit, and the UE 120 may receive, a MAC-CE or another suitable L1 or L2 message triggering an LTM cell switch (e.g., the message triggering the LTM cell switch may be referred to herein as a cell switch command, an LTM cell switch command MAC-CE, a MAC-CE carrying a cell switch command, or the like). The cell switch command may indicate a candidate configuration index associated with the LTM target cell. As shown by reference number 650, based at least in part on the cell switch command, the UE 120 may switch to the configuration of the LTM target cell (e.g., the UE 120 may detach from the source cell and apply the configuration of the LTM target cell). Moreover, as shown by reference number 655, the UE 120 may perform a RACH procedure towards the LTM target cell, such as when a timing advance associated with the target cell is not available (e.g., in cases in which the UE 120 did not perform the early synchronization described above in connection with reference number 630 and/or the LTM cell switch command does not indicate a valid timing advance for the LTM target cell).

As shown by reference number 660, during the LTM completion phase, the UE 120 may indicate successful completion of the LTM cell switch towards the LTM target cell. In this way, a cell switch or handover to a target cell may be performed using L1/L2 signaling, which is associated with less overhead than an L3 handover procedure and/or a reduced latency relative to an L3 handover procedure.

As indicated above, FIG. 6 is provided as an example. Other examples may differ from what is described with regard to FIG. 6.

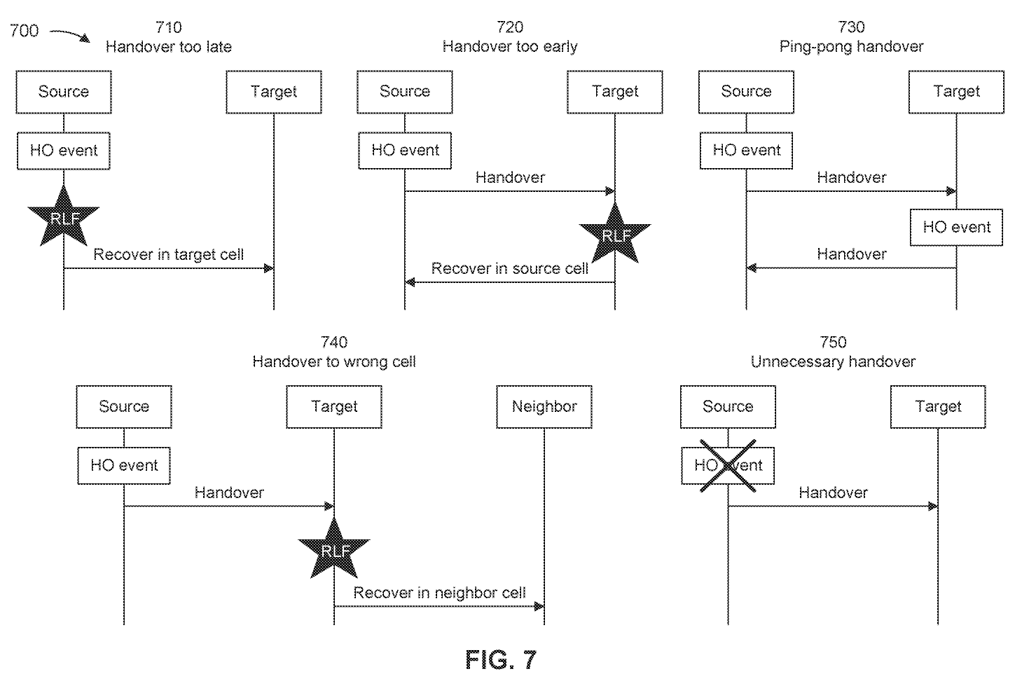

FIG. 7 is a diagram illustrating examples 700 of handover failures, in accordance with the present disclosure. As shown in FIG. 7, examples 700 each include a source network node and a target network node associated with a handover for a UE (not explicitly shown in FIG. 7). In some aspects, source network nodes, target network nodes, and/or other network nodes shown in FIG. 7 may communicate in a wireless network, such as wireless network 100, via a wired or wireless backhaul link, via a wired or wireless midhaul link, and/or via a wired or wireless fronthaul link.

As described herein, handover procedures are generally managed in accordance with various mobility parameters. For example, a network node may provide a UE with an RRC configuration that indicates configured values for various mobility parameters associated with various mobility events, such as values for one or more thresholds that are used to evaluate serving cell measurements and/or neighbor cell measurements, one or more hysteresis parameters that define margins to stabilize handover decisions and avoid frequent and/or unnecessary handovers that result from short-term fluctuations in signal strengths, and/or one or more TTT parameters that define a delay between a time when a handover condition is satisfied and a time when the handover is triggered or initiated. For example, a measurement report may be triggered, candidate target cells may be prepared, a handover condition may be satisfied, and/or a handover may be triggered when a condition associated with one or more mobility events occur. For example, a condition associated with a mobility event may be satisfied when a serving cell measurement fails to satisfy a threshold, when a difference between a neighbor cell measurement and a serving cell measurement satisfies a threshold, when a neighbor cell measurement satisfies a threshold, and/or when a serving cell measurement fails to satisfy a first threshold and a neighbor cell measurement satisfies a second threshold, among other examples. In some cases, each mobility event may be associated with separate values for mobility parameters, such as values for the relevant threshold(s), hysteresis parameter(s), offset(s), and/or TTT parameter(s). Furthermore, in some cases, mobility parameters may be configured for events associated with intra-RAT (e.g., intra-frequency and/or inter-frequency) handovers, such as A1-A6 events, and/or intra-RAT handovers, such as B1-B2 events.

Although handover procedures and the configured values for mobility parameters are generally defined to ensure seamless mobility, there are various circumstances where a handover failure or mobility failure may occur. For example, as shown by reference number 710, a mobility failure may occur when a handover occurs too late, such that a UE experiences RLF in a source cell and recovers from the RLF in a target cell. For example, in the scenario shown by reference number 710, a handover event may occur in the source cell (e.g., a difference between a neighbor cell measurement and a serving cell measurement satisfies a threshold), but RLF occurs in the source cell before the TTT expires. Alternatively, RLF may occur in the source cell without any handover event occurring (e.g., a threshold for evaluating a serving cell measurement is too high, such that a handover event related to a serving cell measurement failing to satisfy a threshold does not occur).

Additionally, or alternatively, as shown by reference number 720, a mobility failure may occur when a handover occurs too early, such that a UE experiences RLF in a target cell after a handover and recovers from the RLF in a source cell. For example, in the scenario shown by reference number 720, a handover event may occur in the source cell (e.g., a difference between a neighbor cell measurement and a serving cell measurement satisfies a threshold), the UE may be handed over to the target cell after the TTT expires, and RLF then occurs in the target cell (e.g., the TTT value may be too small, such that the difference between the neighbor cell measurement and the serving cell measurement may cease to satisfy the threshold after the TTT expires).

Additionally, or alternatively, as shown by reference number 730, a mobility failure may occur when a first handover is triggered from a source cell to a target cell and a second handover is triggered from the target cell back to the original source cell, also known as a ping-pong handover. Additionally, or alternatively, as shown by reference number 740, a mobility failure may occur when a handover is triggered to a wrong target cell, where a UE may experience RLF in the target cell following the handover and recovers from the RLF in a different neighbor cell. Additionally, or alternatively, as shown by reference number 750, a mobility failure may occur when a handover is unnecessary, such as when coverage provided by the source cell was adequate for a service used by the UE.

Accordingly, because there are various scenarios where a mobility failure may occur, a wireless network may support MRO techniques to detect and correct mobility failures. For example, network nodes associated with different serving cells may be configured to provide handover reports, failure indications, RLF reports, and/or other information that indicates whether a handover succeeded or failed, or whether a UE recovered from RLF in a cell, such that one or more mobility parameters may be tuned or optimized to reduce mobility failures (e.g., changing values for one or more thresholds, hysteresis parameters, TTT parameters, and/or other suitable mobility parameters to increase or decrease handover sensitivity, accelerate or delay handovers, and/or configure larger or smaller hysteresis margins, among other examples). Furthermore, in some cases, a UE may be configured to adjust the values for one or more mobility parameters prior to and/or during a handover procedure. For example, a UE may increase or decrease a configured value for one or more thresholds, hysteresis parameters, TTT parameters, or the like, to prevent a handover to a potentially unsuitable target cell and/or to accelerate a handover from an unsuitable serving cell and/or to a suitable target cell, among other examples. However, when a UE adjusts the values for one or more mobility parameters, the UE does not provide information related to the adjustment to the mobility parameters to a network node. Accordingly, mobility parameters are tuned or optimized only according to the MRO signaling between network nodes, which may result in suboptimal parameter tuning and additional mobility failures that consume resources and interrupt communications.

Accordingly, some aspects described herein generally relate to a reporting configuration for UE-adjusted mobility parameters. For example, in some aspects, a network node may provide a UE with an MDT configuration or another suitable configuration to obtain, from the UE, information related to the UE adjusting one or more mobility parameters such that the information can be used to tune values for one or more thresholds, hysteresis parameters, TTT parameters, or the like (e.g., in combination with MRO statistics that are collected from handover reports, failure reports, or other information communicated between and among network nodes when a handover succeeds or fails). For example, when a UE indicates a capability to support UE-adjusted mobility, a network node may provide the UE with a configuration that allows the UE to adjust configured values for one or more mobility parameters. In some aspects, when the configuration indicates that the UE is allowed to adjust configured values for one or more mobility parameters, the configuration may further indicate constraints for the adjustment to the configured values for the one or more mobility parameters (e.g., one or more conditions under which the UE is allowed to adjust configured values for one or more mobility parameters and/or a range within which the configured values can be adjusted). Accordingly, when the UE adjusts the configured values for one or more mobility parameters, the UE may be configured to transmit, to the network node, information related to the adjustment to the mobility parameters. For example, in some aspects, the information related to the adjustment to the mobility parameters may indicate the configured values for the adjusted mobility parameters, the adjusted values for the mobility parameters, and/or a reason or cause for the adjustment to the configured values for the mobility parameters, among other examples.

In this way, by configuring a UE to report information related to an adjustment to configured values for one or more mobility parameters, some aspects described herein can be used to obtain information from UEs that may be used, alone or in combination with MRO statistics, to tune or otherwise optimize values for one or more mobility parameters. In this way, the values for one or more mobility parameters may be tuned or optimized to reduce mobility failures or handover failures, which conserves UE resources and network resources that would otherwise be consumed and prevents service interruptions that would otherwise occur when a UE experiences RLF before a handover is triggered, when a UE experiences RLF occurs after a handover is triggered, when ping-pong handovers occur, and/or when a handover is unnecessarily triggered from a serving cell that provides acceptable performance for a UE service.

As indicated above, FIG. 7 is provided as an example. Other examples may differ from what is described with regard to FIG. 7.

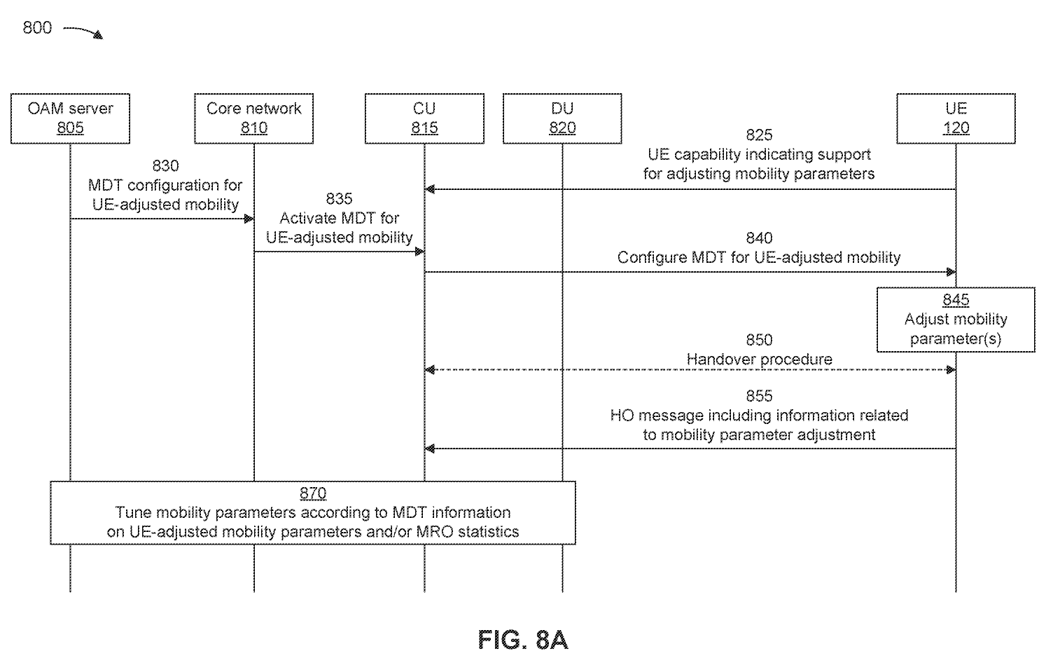

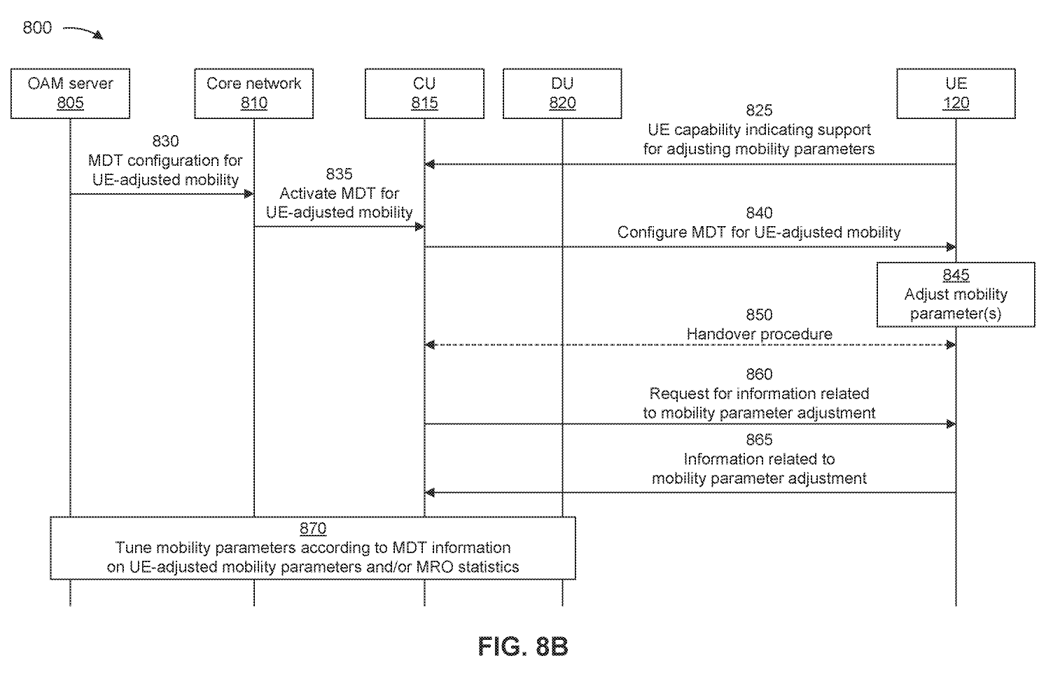

FIGS. 8A-8B are diagrams illustrating examples 800 associated with reporting for UE-adjusted mobility parameters, in accordance with the present disclosure. As shown in FIGS. 8A-8B, examples 800 include communication among an operations, administration, and management (OAM) server 805, a core network 810, a CU 815, a DU 820, and a UE 120. The core network 810 may include one or more core network devices, such as an AMF and a UPF, among other examples. In some aspects, the CU 815 may be a first network node and the DU 820 may be a second network node, or the CU 815 and the DU 820 may be included in the same network node.

As shown in FIGS. 8A-8B, and by reference number 825, the UE 120 may transmit, and the CU 815 may receive (e.g., via the DU 820), signaling indicating that the UE 120 has a capability to adjust one or more mobility parameters. For example, as described herein, the UE 120 may be configured to transmit a measurement report (e.g., an L3 measurement report or an L1 measurement report), or may be configured to execute a handover command, when a condition associated with a mobility event is satisfied. For example, as described herein, mobility events may include intra-RAT mobility events associated with intra-frequency and/or inter-frequency handovers, also known as Ax events, inter-RAT mobility events associated with inter-RAT handovers, also known as Bx events, interference-based mobility events, also known as Ix events, and/or distance-based mobility events, also known as Dx events, where x is an integer associated with a particular mobility event (e.g., as defined in 3GPP Technical Specification 38.331). In general, each mobility event is associated with one or more mobility parameters that are used to evaluate mobility-related measurements. For example, the mobility parameters associated with a mobility event may include one or more threshold values, one or more hysteresis parameters, one or more offset parameters, and/or a TTT value. For example, an A2 event related to a serving cell measurement being worse than a threshold may be associated with a threshold value expressed using the same unit as a serving cell measurement and a hysteresis parameter expressed in decibels (dB), and the A2 event may be satisfied when a value of the serving cell measurement plus the value of the hysteresis parameter is less than the threshold value. Accordingly, in an example where the UE 120 has a capability to adjust one or more mobility parameters, the UE 120 may support adjusting the threshold value or the value of the hysteresis parameter for an A2 event. Furthermore, the UE 120 capability may similarly apply to other mobility parameters, including other Ax events, Bx events, Ix events, and/or Dx events, among other examples.

As further shown in FIGS. 8A-8B, and by reference number 830, the OAM server 805 may transmit, and the core network 810 may receive, an MDT configuration or another suitable reporting configuration for UE-adjusted mobility. In some aspects, as described herein, the MDT configuration or other reporting configuration for UE-adjusted mobility may include one or more parameters that configures the core network 810 for enabling or disabling UE-adjusted mobility, and/or for collecting information from UEs that support UE-adjusted mobility. For example, in some aspects, the MDT configuration or other reporting configuration provided from the OAM server 805 to the core network 810 may indicate one or more mobility events for which UE-adjusted mobility is to be enabled or disabled, mobility parameters that are allowed to be adjusted or disallowed from adjustment, ranges within which the mobility parameters are allowed to be adjusted, and/or conditions under which the mobility parameters are allowed to be adjusted. Additionally, or alternatively, the MDT configuration or other reporting configuration provided from the OAM server 805 to the core network 810 may indicate one or more cells or regions where UE-adjusted mobility is enabled or disabled, and/or one or more criteria or parameters that control whether UE-adjusted mobility is enabled or disabled for a particular cell, region, or the like.

As further shown in FIGS. 8A-8B, and by reference number 835, the core network 810 may transmit, and the CU 815 may receive, a message to activate an MDT or reporting configuration associated with UE-adjusted mobility for the UE 120. For example, in some aspects, the core network 810 may activate MDT or reporting configuration associated with UE-adjusted mobility for the UE 120 in accordance with the UE 120 signaling a capability to adjust one or more mobility parameters.

As further shown in FIGS. 8A-8B, and by reference number 840, the CU 815 may transmit, and the UE 120 may receive (e.g., via the DU 820), an MDT configuration or another suitable reporting configuration for UE-adjusted mobility. For example, in some aspects, the MDT configuration or another suitable reporting configuration for UE-adjusted mobility may be provided via RRC signaling, and may indicate one or more parameters that relate to whether and/or how the UE 120 can adjust one or more mobility parameters. For example, in some aspects, the UE 120 may receive an RRC configuration that indicates threshold values, hysteresis parameter values, offset values, TTT values, and/or other suitable values for one or more mobility events. Accordingly, the MDT configuration or another suitable reporting configuration for UE-adjusted mobility may indicate whether the UE 120 is allowed or not allowed to adjust the RRC-configured values of the mobility parameters.

In some aspects, in cases where the MDT configuration or other reporting configuration indicates that the UE 120 is allowed to adjust the RRC-configured values of the mobility parameters, the MDT configuration or other reporting configuration may indicate which mobility parameters can be adjusted (e.g., mobility parameters associated with certain events, such as Ax and Bx events only, certain types of mobility parameters, such as threshold values or TTT values only, or the like). Furthermore, in some aspects, the MDT configuration or other reporting configuration may indicate one or more conditions associated with the UE 120 adjusting the mobility parameters. For example, the MDT configuration or other reporting configuration may indicate that a mobility parameter can be adjusted in accordance with a serving cell measurement (e.g., an RSRP or SINR associated with the serving cell), a neighbor cell measurement (e.g., an RSRP or SINR associated with the neighbor cell), a difference between a serving cell measurement and a neighbor cell measurement, a state of an RLF timer (e.g., whether an RLF timer has started and/or an amount of time until the RLF timer expires if the RLF timer has started), and/or one or more user experience (Ux) or quality of experience (QoE) measurements associated with an application. For example, for a streaming service or XR application, Ux or QoE measurements may relate to an average throughput, initial playback delay, buffer level, jitter, or the like. In other examples, the relevant Ux or QoE measurements may vary depending on the important parameters associated with the application (e.g., different Ux or QoE parameters may indicate poor voice quality for a voice over LTE (VoLTE) or voice over NR (VoNR) call). Furthermore, in cases where the MDT configuration or other reporting configuration indicates that the UE 120 is allowed to adjust the RRC-configured values of one or more mobility parameters, the MDT configuration or other reporting configuration may indicate a range of allowed values or set of allowed candidate values for the one or more mobility parameters (e.g., maximum and minimum values, or the like).

As further shown in FIGS. 8A-8B, and by reference number 845, the UE 120 may adjust one or more mobility parameters in accordance with the configuration provided by the CU 815. For example, in some aspects, the UE 120 may adjust (e.g., increase or decrease) the RRC-configured value for one or more thresholds, hysteresis parameters, offsets, TTT parameters, and/or other suitable parameters for one or more mobility events. In this way, the UE 120 may adjust the one or more mobility parameters to increase or decrease a probability that a condition associated with a mobility event will be satisfied, to increase or decrease a probability that a handover will be triggered from a source cell to a target cell, to decrease a probability of ping-pong handovers, to accelerate or delay a handover, or the like. In some aspects, the UE 120 may adjust the RRC-configured value for a mobility parameter in accordance with a determination that any conditions associated with the adjustment are satisfied (e.g., a serving cell measurement, neighbor cell measurement, RLF timer, Ux or QoE parameter, or the like, satisfies any configured conditions associated with adjusting the RRC-configured value for the mobility parameter). Furthermore, in some aspects, the UE 120 may adjust the RRC-configured value for the mobility parameter within the configured range for the value of mobility parameter, and/or to a candidate value in a set of allowed candidate values for the mobility parameter. In some aspects, the RRC-configured value for the mobility parameter may be adjusted in connection with a legacy (e.g., L3 or MBB) handover procedure, a conditional handover procedure, an LTM handover procedure, or another suitable handover procedure.

As further shown in FIGS. 8A-8B, and by reference number 850, the UE 120 may (or may not) perform a handover procedure in accordance with the adjusted value(s) for the mobility parameter(s). For example, as described herein, the UE 120 may be configured to transmit (or not transmit) a measurement report, or to execute (or not execute) a conditional handover command, when one or more mobility events occur or when one or more conditions associated with a mobility event are otherwise satisfied. Furthermore, when a mobility event is associated with a TTT parameter, the UE 120 may transmit the measurement report or execute the conditional handover command only when the mobility event persists, and remains satisfied until the TTT expires. Accordingly, as described herein, the UE 120 may adjust one or more thresholds, hysteresis parameters, offsets, and/or other suitable parameters, such that one or more mobility events triggering a measurement report or handover execution may be satisfied or not satisfied in accordance with values for one or more measurements and the adjusted value(s) of the mobility parameter(s). Furthermore, in some cases, whether the measurement report is transmitted or the handover is executed may depend on the adjusted value of a TTT parameter associated with the corresponding mobility event.

In some aspects, the UE 120 may then report information related to the adjustment to the one or more mobility parameter values to the CU 815 (e.g., via the DU 820) in accordance with an outcome from the handover procedure (e.g., whether a measurement report was triggered, whether a handover event or condition was satisfied, whether a handover was triggered or executed upon TTT expiration, and/or whether a triggered or executed handover succeeded or failed, among other examples).

For example, as shown in FIG. 8A, and by reference number 855, the UE 120 may transmit, and the CU 815 may receive (e.g., via the DU 820), the information related to the adjustment to the one or more mobility parameter values in a handover complete message or a MAC-CE that indicates whether a handover procedure succeeded or failed in cases where the adjustment to the one or more mobility parameter values resulted in a handover procedure being triggered and/or executed. Additionally, or alternatively, as shown in FIG. 8B, the UE 120 may report the information related to the adjustment to the one or more mobility parameter values in response to a request from the CU 815, which may follow a triggered and/or executed handover procedure or be independent from a triggered and/or executed handover procedure (e.g., such that the CU 815 can request and obtain the information related to the adjustment to the one or more mobility parameter values in cases where the adjustment to the mobility parameter value(s) resulted in a handover procedure not being triggered or executed). For example, as shown by reference number 860 in FIG. 8B, the CU 815 may transmit, and the UE 120 may receive (e.g., via the DU 820), a request for the information related the adjustment to the one or more mobility parameter values. As further shown by reference number 865, the UE 120 may then transmit, and the CU 815 may receive (e.g., via the DU 820), the information related the adjustment to the one or more mobility parameter values. For example, in some aspects, the information that the UE 120 provides may indicate the RRC-configured values for one or more mobility parameters that were adjusted by the UE 120 and/or the adjusted values for the one or more mobility parameters that were adjusted by the UE 120. Additionally, or alternatively, the information that the UE 120 provides to the CU 815 may indicate other suitable information, such as a reason or cause for the UE 120 adjustment to the RRC-configured values for the one or more mobility parameters (e.g., a serving cell measurement, neighbor cell measurement, difference between a serving cell and neighbor cell measurement, RLF timer state, Ux or QoE parameters, or the like) and/or a quality of service (QoS) identifier or application associated with the adjustment to the RRC-configured values for one or more mobility parameters (e.g., a voice application, XR application, or the like), among other examples.

Accordingly, as shown in FIGS. 8A-8B, and by reference number 870, one or more network entities may then tune or otherwise optimize one or more mobility parameter values according to the information reported by the UE 120, in combination with mobility parameter adjustments by other UEs 120 and/or MRO statistics collected by the one or more network entities. For example, in some aspects, the CU 815 may forward the information reported by the UE 120 to the OAM server 805 to change the default values for one or more thresholds, hysteresis parameters, offsets, TTT parameters, or other suitable parameters associated with one or more mobility events to reduce the number or probability of mobility or handover failures (e.g., late handovers, early handovers, ping-pong handovers, handovers to a wrong cell, and/or unnecessary handovers, among other examples).

As indicated above, FIGS. 8A-8B are provided as examples. Other examples may differ from what is described with respect to FIGS. 8A-8B.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with reporting for UE-adjusted mobility parameters.

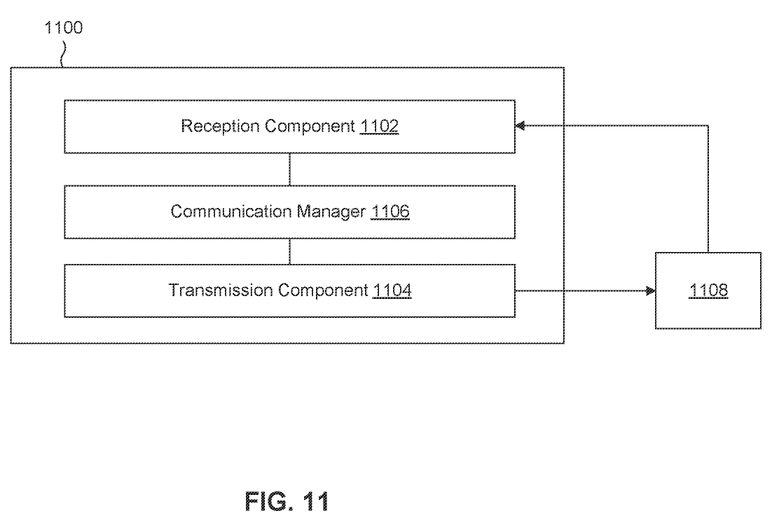

As shown in FIG. 9, in some aspects, process 900 may include receiving, from a network node, a configuration allowing an adjustment within a range to a configured value associated with a mobility parameter and indicating one or more conditions associated with the adjustment to the configured value (block 910). For example, the UE (e.g., using reception component 1102 and/or communication manager 1106, depicted in FIG. 11) may receive, from a network node, a configuration allowing an adjustment within a range to a configured value associated with a mobility parameter and indicating one or more conditions associated with the adjustment to the configured value, as described above.

As further shown in FIG. 9, in some aspects, process 900 may include adjusting, within the range, the configured value associated with the mobility parameter in accordance with the one or more conditions being satisfied (block 920). For example, the UE (e.g., using communication manager 1106, depicted in FIG. 11) may adjust, within the range, the configured value associated with the mobility parameter in accordance with the one or more conditions being satisfied, as described above.

As further shown in FIG. 9, in some aspects, process 900 may include transmitting, to the network node, information related to adjusting the configured value associated with the mobility parameter (block 930). For example, the UE (e.g., using transmission component 1104 and/or communication manager 1106, depicted in FIG. 11) may transmit, to the network node, information related to adjusting the configured value associated with the mobility parameter, as described above.

Process 900 may include additional aspects, such as any single aspect or any combination of aspects described below and/or in connection with one or more other processes described elsewhere herein.

In a first aspect, the one or more conditions relate to one or more of a measurement associated with a serving cell, a measurement associated with a neighbor cell, or a difference between the measurement associated with the serving cell and the measurement associated with the neighbor cell.

In a second aspect, alone or in combination with the first aspect, the one or more conditions relate to a state associated with an RLF timer.

In a third aspect, alone or in combination with one or more of the first and second aspects, the one or more conditions relate to one or more Ux or QoE measurements.

In a fourth aspect, alone or in combination with one or more of the first through third aspects, the configuration indicates the range for the adjustment to the configured value associated with the mobility parameter according to a minimum value and a maximum value.

In a fifth aspect, alone or in combination with one or more of the first through fourth aspects, the transmitted information indicates the configured value associated with the mobility parameter.

In a sixth aspect, alone or in combination with one or more of the first through fifth aspects, the transmitted information indicates an adjusted value associated with the mobility parameter.

In a seventh aspect, alone or in combination with one or more of the first through sixth aspects, the transmitted information indicates a reason for adjusting the configured value associated with the mobility parameter.

In an eighth aspect, alone or in combination with one or more of the first through seventh aspects, the transmitted information indicates a QoS identifier or an application associated with adjusting the configured value associated with the mobility parameter.

In a ninth aspect, alone or in combination with one or more of the first through eighth aspects, the information related to adjusting the configured value associated with the mobility parameter is included in a handover complete message or a message indicating a successful or failed handover procedure.

In a tenth aspect, alone or in combination with one or more of the first through ninth aspects, process 900 includes receiving, from the network node, a request for the information related to adjusting the configured value associated with the mobility parameter, wherein the information is transmitted in response to the request.

In an eleventh aspect, alone or in combination with one or more of the first through tenth aspects, process 900 includes transmitting, to the network node, information indicating a capability to adjust one or more mobility parameters.

In a twelfth aspect, alone or in combination with one or more of the first through eleventh aspects, the mobility parameter includes one or more of a threshold, a hysteresis, or a time-to-trigger associated with a handover event.

In a thirteenth aspect, alone or in combination with one or more of the first through twelfth aspects, the adjusted value associated with the mobility parameter is determined using an AI/ML model.

In a fourteenth aspect, alone or in combination with one or more of the first through thirteenth aspects, the adjusted value associated with the mobility parameter is determined according to a predicted QoE for one or more applications.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with reporting for UE-adjusted mobility parameters.

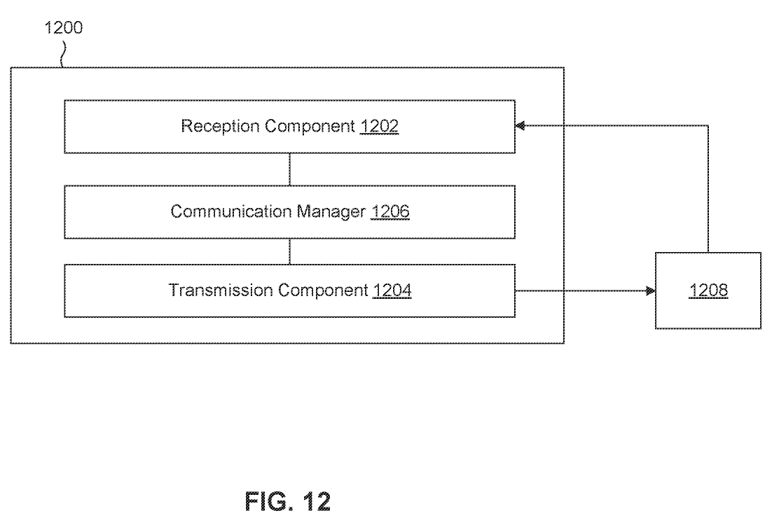

As shown in FIG. 10, in some aspects, process 1000 may include transmitting, to a UE, a configuration allowing an adjustment within a range to a configured value associated with a mobility parameter and indicating one or more conditions associated with the adjustment to the configured value (block 1010). For example, the network node (e.g., using transmission component 1204 and/or communication manager 1206, depicted in FIG. 12) may transmit, to a UE, a configuration allowing an adjustment within a range to a configured value associated with a mobility parameter and indicating one or more conditions associated with the adjustment to the configured value, as described above.

As further shown in FIG. 10, in some aspects, process 1000 may include receiving, from the UE, information related to the UE adjusting, within the range, the configured value associated with the mobility parameter (block 1020). For example, the network node (e.g., using reception component 1202 and/or communication manager 1206, depicted in FIG. 12) may receive, from the UE, information related to the UE adjusting, within the range, the configured value associated with the mobility parameter, as described above.

Process 1000 may include additional aspects, such as any single aspect or any combination of aspects described below and/or in connection with one or more other processes described elsewhere herein.

In a first aspect, the one or more conditions relate to one or more of a measurement associated with a serving cell, a measurement associated with a neighbor cell, or a difference between the measurement associated with the serving cell and the measurement associated with the neighbor cell.

In a second aspect, alone or in combination with the first aspect, the one or more conditions relate to a state associated with an RLF timer.

In a third aspect, alone or in combination with one or more of the first and second aspects, the one or more conditions relate to one or more Ux or QoE measurements.

In a fourth aspect, alone or in combination with one or more of the first through third aspects, the configuration indicates the range for the adjustment to the configured value associated with the mobility parameter according to a minimum value and a maximum value.

In a fifth aspect, alone or in combination with one or more of the first through fourth aspects, the received information indicates the configured value associated with the mobility parameter.

In a sixth aspect, alone or in combination with one or more of the first through fifth aspects, the received information indicates an adjusted value associated with the mobility parameter.

In a seventh aspect, alone or in combination with one or more of the first through sixth aspects, the received information indicates a reason for the UE adjusting the configured value associated with the mobility parameter.

In an eighth aspect, alone or in combination with one or more of the first through seventh aspects, the received information indicates a QoS identifier or an application associated with adjusting the configured value associated with the mobility parameter.

In a ninth aspect, alone or in combination with one or more of the first through eighth aspects, the information related to adjusting the configured value associated with the mobility parameter is included in a handover complete message or a message indicating a successful or failed handover procedure.

In a tenth aspect, alone or in combination with one or more of the first through ninth aspects, process 1000 includes transmitting, to the UE, a request for the information related to adjusting the configured value associated with the mobility parameter, wherein the information received from the UE is responsive to the request.

In an eleventh aspect, alone or in combination with one or more of the first through tenth aspects, process 1000 includes receiving, from the UE, information indicating a capability to adjust one or more mobility parameters.

In a twelfth aspect, alone or in combination with one or more of the first through eleventh aspects, the mobility parameter includes one or more of a threshold, a hysteresis, or a time-to-trigger associated with a handover event.

In a thirteenth aspect, alone or in combination with one or more of the first through twelfth aspects, process 1000 includes receiving, from a core network node, a message to activate reporting associated with the configuration allowing the adjustment to the configured value associated with the mobility parameter.

In a fourteenth aspect, alone or in combination with one or more of the first through thirteenth aspects, process 1000 includes forwarding the information related to the UE adjusting the configured value associated with the mobility parameter to one or more of a core network node or an operations, administration, and maintenance entity.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 8A-8B. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node, a configuration allowing an adjustment within a range to a configured value associated with a mobility parameter and indicating one or more conditions associated with the adjustment to the configured value. The communication manager 1106 may adjust, within the range, the configured value associated with the mobility parameter in accordance with the one or more conditions being satisfied. The transmission component 1104 may transmit, to the network node, information related to adjusting the configured value associated with the mobility parameter. In some aspects, the transmitted information indicates one or more of an adjusted value associated with the mobility parameter or a reason for adjusting the configured value associated with the mobility parameter.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 8A-8B. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIGS. 1 and 2. Additionally, or alternatively, one or more components shown in FIG. 12 may be implemented within one or more components described in connection with FIGS. 1 and 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIGS. 1 and 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIGS. 1 and 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, a configuration allowing an adjustment within a range to a configured value associated with a mobility parameter and indicating one or more conditions associated with the adjustment to the configured value. The reception component 1202 may receive, from the UE, information related to the UE adjusting, within the range, the configured value associated with the mobility parameter. In some aspects, the received information indicates one or more of an adjusted value associated with the mobility parameter or a reason for adjusting the configured value associated with the mobility parameter.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving, from a network node, a configuration allowing an adjustment within a range to a configured value associated with a mobility parameter and indicating one or more conditions associated with the adjustment to the configured value; adjusting, within the range, the configured value associated with the mobility parameter in accordance with the one or more conditions being satisfied; and transmitting, to the network node, information related to adjusting the configured value associated with the mobility parameter.

Aspect 2: The method of Aspect 1, wherein the one or more conditions relate to one or more of a measurement associated with a serving cell, a measurement associated with a neighbor cell, or a difference between the measurement associated with the serving cell and the measurement associated with the neighbor cell.

Aspect 3: The method of any of Aspects 1-2, wherein the one or more conditions relate to a state associated with an RLF timer.

Aspect 4: The method of any of Aspects 1-3, wherein the one or more conditions relate to one or more Ux or QoE measurements.

Aspect 5: The method of any of Aspects 1-4, wherein the configuration indicates the range for the adjustment to the configured value associated with the mobility parameter according to a minimum value and a maximum value.

Aspect 6: The method of any of Aspects 1-5, wherein the transmitted information indicates the configured value associated with the mobility parameter.

Aspect 7: The method of any of Aspects 1-6, wherein the transmitted information indicates an adjusted value associated with the mobility parameter.

Aspect 8: The method of any of Aspects 1-7, wherein the transmitted information indicates a reason for adjusting the configured value associated with the mobility parameter.

Aspect 9: The method of any of Aspects 1-8, wherein the transmitted information indicates a QoS identifier or an application associated with adjusting the configured value associated with the mobility parameter.

Aspect 10: The method of any of Aspects 1-9, wherein the information related to adjusting the configured value associated with the mobility parameter is included in a handover complete message or a message indicating a successful or failed handover procedure.

Aspect 11: The method of any of Aspects 1-10, further comprising: receiving, from the network node, a request for the information related to adjusting the configured value associated with the mobility parameter, wherein the information is transmitted in response to the request.

Aspect 12: The method of any of Aspects 1-11, further comprising: transmitting, to the network node, information indicating a capability to adjust one or more mobility parameters.

Aspect 13: The method of any of Aspects 1-12, wherein the mobility parameter includes one or more of a threshold, a hysteresis, or a time-to-trigger associated with a handover event.

Aspect 14: The method of any of Aspects 1-13, wherein the adjusted value associated with the mobility parameter is determined using an AI/ML model.

Aspect 15: The method of any of Aspects 1-14, wherein the adjusted value associated with the mobility parameter is determined according to a predicted QoE for one or more applications.

Aspect 16: A method of wireless communication performed by a network node, comprising: transmitting, to a UE, a configuration allowing an adjustment within a range to a configured value associated with a mobility parameter and indicating one or more conditions associated with the adjustment to the configured value; and receiving, from the UE, information related to the UE adjusting, within the range, the configured value associated with the mobility parameter.

Aspect 17: The method of Aspect 16, wherein the one or more conditions relate to one or more of a measurement associated with a serving cell, a measurement associated with a neighbor cell, or a difference between the measurement associated with the serving cell and the measurement associated with the neighbor cell.

Aspect 18: The method of any of Aspects 16-17, wherein the one or more conditions relate to a state associated with an RLF timer.

Aspect 19: The method of any of Aspects 16-18, wherein the one or more conditions relate to one or more Ux or QoE measurements.

Aspect 20: The method of any of Aspects 16-19, wherein the configuration indicates the range for the adjustment to the configured value associated with the mobility parameter according to a minimum value and a maximum value.

Aspect 21: The method of any of Aspects 16-20, wherein the received information indicates the configured value associated with the mobility parameter.

Aspect 22: The method of any of Aspects 16-21, wherein the received information indicates an adjusted value associated with the mobility parameter.

Aspect 23: The method of any of Aspects 16-22, wherein the received information indicates a reason for the UE adjusting the configured value associated with the mobility parameter.

Aspect 24: The method of any of Aspects 16-23, wherein the received information indicates a QoS identifier or an application associated with adjusting the configured value associated with the mobility parameter.

Aspect 25: The method of any of Aspects 16-24, wherein the information related to adjusting the configured value associated with the mobility parameter is included in a handover complete message or a message indicating a successful or failed handover procedure.

Aspect 26: The method of any of Aspects 16-25, further comprising: transmitting, to the UE, a request for the information related to adjusting the configured value associated with the mobility parameter, wherein the information received from the UE is responsive to the request.

Aspect 27: The method of any of Aspects 16-26, further comprising: receiving, from the UE, information indicating a capability to adjust one or more mobility parameters.

Aspect 28: The method of any of Aspects 16-27, wherein the mobility parameter includes one or more of a threshold, a hysteresis, or a time-to-trigger associated with a handover event.

Aspect 29: The method of any of Aspects 16-28, further comprising: receiving, from a core network node, a message to activate reporting associated with the configuration allowing the adjustment to the configured value associated with the mobility parameter.

Aspect 30: The method of any of Aspects 16-29, further comprising: forwarding the information related to the UE adjusting the configured value associated with the mobility parameter to one or more of a core network node or an operations, administration, and maintenance entity.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, a configuration allowing an adjustment within a range to a configured value associated with a mobility parameter and indicating one or more conditions associated with the adjustment to the configured value;
adjust, within the range, the configured value associated with the mobility parameter in accordance with the one or more conditions being satisfied; and
transmit, to the network node, information related to adjusting the configured value associated with the mobility parameter, wherein the transmitted information indicates one or more of an adjusted value associated with the mobility parameter or a reason for adjusting the configured value associated with the mobility parameter.

2. The UE of claim 1, wherein the one or more conditions relate to one or more of a measurement associated with a serving cell, a measurement associated with a neighbor cell, or a difference between the measurement associated with the serving cell and the measurement associated with the neighbor cell.

3. The UE of claim 1, wherein the one or more conditions relate to a state associated with a radio link failure timer.

4. The UE of claim 1, wherein the one or more conditions relate to one or more user experience or quality of experience measurements.

5. The UE of claim 1, wherein the configuration indicates the range for the adjustment to the configured value associated with the mobility parameter according to a minimum value and a maximum value.

6. The UE of claim 1, wherein the transmitted information indicates the configured value associated with the mobility parameter.

7. The UE of claim 1, wherein the transmitted information indicates a quality of service identifier or an application associated with adjusting the configured value associated with the mobility parameter.

8. The UE of claim 1, wherein the information related to adjusting the configured value associated with the mobility parameter is included in a handover complete message or a message indicating a successful or failed handover procedure.

9. The UE of claim 1, wherein the one or more processors are further configured to cause the UE to:
receive, from the network node, a request for the information related to adjusting the configured value associated with the mobility parameter, wherein the information is transmitted in response to the request.

10. The UE of claim 1, wherein the one or more processors are further configured to cause the UE to:
transmit, to the network node, information indicating a capability to adjust one or more mobility parameters.

11. The UE of claim 1, wherein the mobility parameter includes one or more of a threshold, a hysteresis, or a time-to-trigger associated with a handover event.

12. The UE of claim 1, wherein the adjusted value associated with the mobility parameter is determined using an artificial intelligence or machine learning (AI/ML) model.

13. The UE of claim 1, wherein the adjusted value associated with the mobility parameter is determined according to a predicted quality of experience (QoE) for one or more applications.

14. A method of wireless communication performed by a user equipment (UE), comprising:
receiving, from a network node, a configuration allowing an adjustment within a range to a configured value associated with a mobility parameter and indicating one or more conditions associated with the adjustment to the configured value;
adjusting, within the range, the configured value associated with the mobility parameter in accordance with the one or more conditions being satisfied; and
transmitting, to the network node, information related to adjusting the configured value associated with the mobility parameter, wherein the transmitted information indicates one or more of an adjusted value associated with the mobility parameter or a reason for adjusting the configured value associated with the mobility parameter.

15. The method of claim 12, wherein the one or more conditions relate to one or more of a measurement associated with a serving cell, a measurement associated with a neighbor cell, a difference between the measurement associated with the serving cell and the measurement associated with the neighbor cell, or a state associated with a radio link failure timer.

16. The method of claim 12, wherein the configuration indicates the range for the adjustment to the configured value associated with the mobility parameter according to a minimum value and a maximum value.

17. The method of claim 12, wherein the transmitted information indicates the configured value associated with the mobility parameter.

18. The method of claim 12, wherein the information related to adjusting the configured value associated with the mobility parameter is included in a handover complete message or a message indicating a successful or failed handover procedure.

19. The method of claim 12, further comprising:
receiving, from the network node, a request for the information related to adjusting the configured value associated with the mobility parameter, wherein the information is transmitted in response to the request.

20. An apparatus for wireless communication, comprising:
means for receiving, from a network node, a configuration allowing an adjustment within a range to a configured value associated with a mobility parameter and indicating one or more conditions associated with the adjustment to the configured value;
means for adjusting the configured value associated with the mobility parameter in accordance with the one or more conditions being satisfied; and
means for transmitting, to the network node, information related to adjusting the configured value associated with the mobility parameter, wherein the transmitted information indicates one or more of an adjusted value associated with the mobility parameter or a reason for adjusting the configured value associated with the mobility parameter.
